(19) United States
(12) Patent Application Publication
(10) Pub. No.: US 2005/0275209 A1
(43) Pub. Date: Dec. 15, 2005

(54) Structure of safety belt adjuster

(76) Inventor: Shih-Hui Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/866,738

(22) Filed: Jun. 15, 2004

(51) Int. Cl. B60R 22/00

(52) U.S. Cl. 280/801.1

(57) ABSTRACT

An improved structure of safety belt adjuster is composed of a base and a cover to adjust the extent of a safety belt in the containing space between the base and the cover; at the same time, fragrance can be spread out via air vent of the cover to eliminate the pressures and fatigue on people caused by the safety belt which has been for a while in use during a trip.

### BACKGROUND OF THE INVENTION

1. Field of the Invention

The invention relates to an improved structure of safety belt adjuster and; more particularly, to a safety belt adjuster placed on the safety belt for motor vehicles, which is able to adjust the length of the safety belt to the desired position; in addition, it is also spread out fragrance via air vent to make drivers or passengers have comfortable and fresh feelings.

2. Prior Art

The prior safety belt is usually fastened fixedly on the human body to the seat for absorbing the energy of the forward inertial force induced by an emergency brake. However, fastening the safety belt tightly for a long while is easy to cause passengers discomfort and easy to bring drivers fatigue as well after they have driven in long distances.

### OBJECTS OF THE INVENTION

The main objective of the present invention is to eliminate the pressure caused by the safety belt, which is placing the safety belt adjuster on the safety belt to adjust the length of the safety belt fastened on the human body; furthermore, placing fragrant materials in the cover of the safety belt adjuster so that the safety belt adjuster not only can spread out fragrance to release the fatigue caused by the safety belt in use for a long while but also can make driving safe and comfortable.

### BRIEF DESCRIPTION OF THE DRAWINGS

These and other features, aspects and advantages of the present invention will become apparent from the following description, claims and the accompanying embodiments shown in the drawings, which are briefly described below.

FIG. 1 is a solid drawing of the external feature of the present invention.

FIG. 2 is a schematic view of the present invention as dismantled.

FIG. 3 is a schematic view of the base and the cover of the present invention as separated.

FIG. 4 is a schematic view of the cover of the present invention.

FIG. 5 is a sectional view of the present invention.

FIG. 6 is a sectional view of the sleeve tube of the present invention.

FIG. 7 is a schematic view of an embodiment of the present invention.

FIG. 8 is a sectional view of the present invention as placed on the safety belt.

FIG. 9 is a sectional view of the present invention in operation state on the safety belt.

### DESCRIPTION OF THE PREFERRED EMBODIMENT

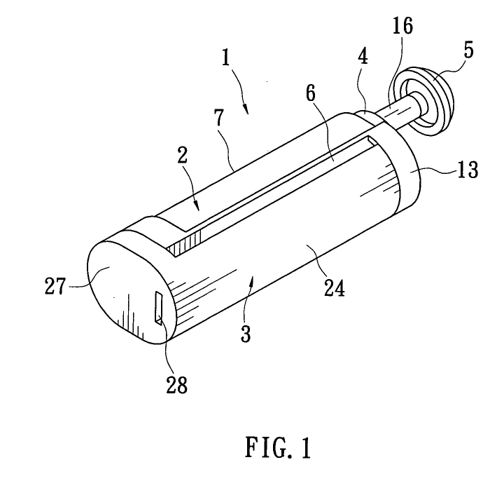

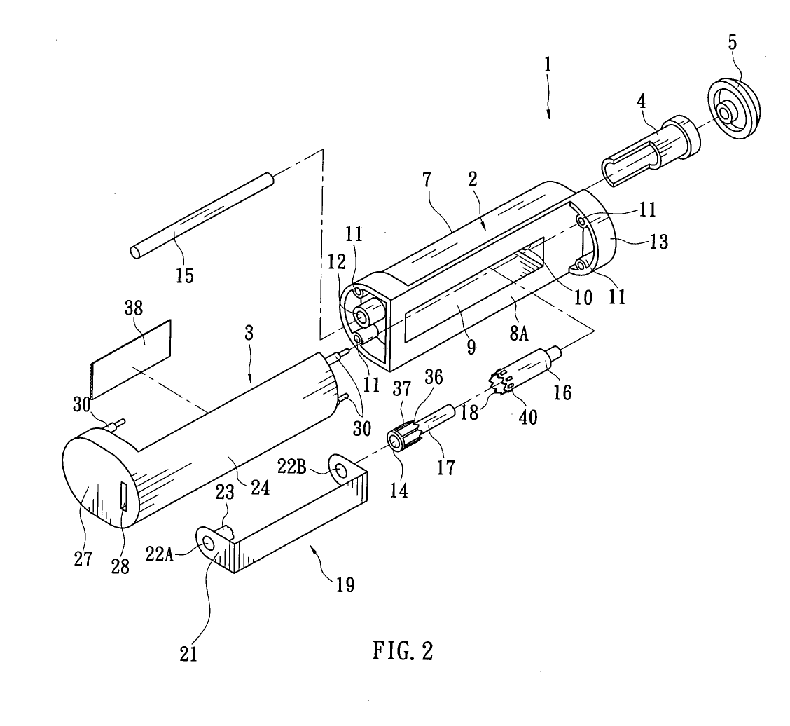

The safety belt adjuster (1) shown in FIG. 1, the embodiment of the present invention, is composed of a base (2) and a cover (3). Referring to FIG. 2, the base (2) is approximately L-shaped, whose one side is a circular face (7) and the other side is a connection face (8A). The connection face (8A) has a curved groove (9) in accordance with the circular face (7). One end of the curved groove (9) extends to have a shaft hole (10) which is for coupling the sleeve tube (4). The plural sleeve hole (11) and guide tube (12) are at one end of the base (2) and the sleeve cover (13), also with the plural sleeve hole (11), is at the other end of the base (2).

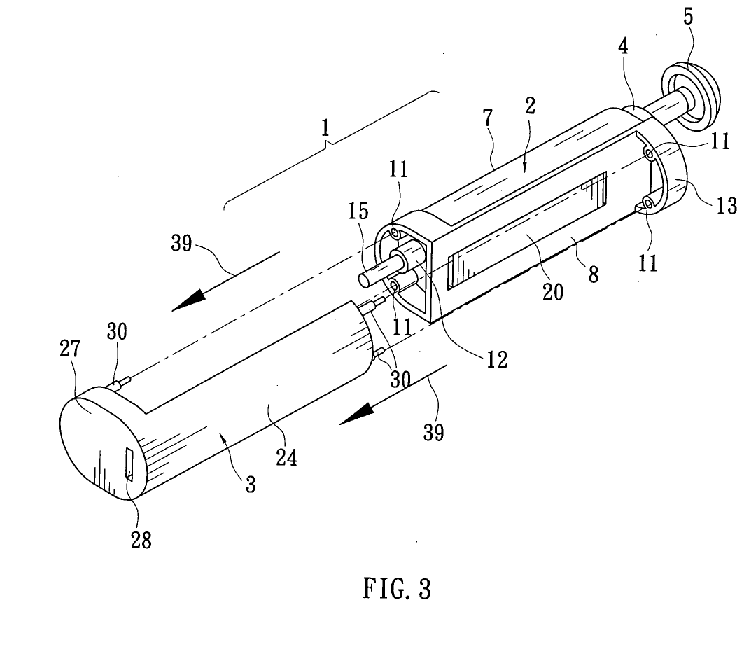

Referring to FIG. 2 and FIG. 3, the inner of the base (2) contains a shaft lever (15), a sleeve tube (4), a motive lever (16), a driven lever (17) and a press-button (5). The sleeve tube (4) is to couple the shaft hole (10) being placed in the base (2). The motive lever (16) is a hollow body placed in the sleeve tube (4). The back end of the motive lever (16) formed into the serrated end (18) has an opening for containing the front end of the driven lever (17); also, it still has the plural convex guide block (40) arranged annularly in the suitable position of the outer side for wedging into the guide track (34) of the sleeve tube (4) so that the motive lever (16) can move forwardly and backwardly in the sleeve tube (4). The front end of the motive lever (16) is bulging out of the sleeve tube (4) for combining with the press-button (5). The front end of the driven lever (17) is inserted into the opening of the motive lever (16). A connection hole (14) and convex blocks (37), arranged annularly on the outer side, are at the back end of the driven lever (17).

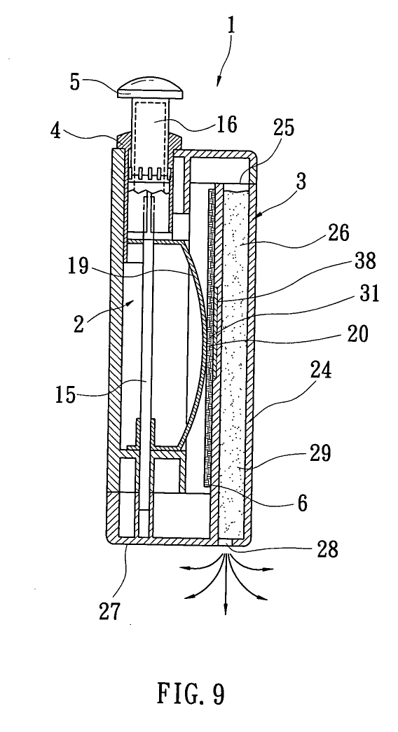

A reed (19), to be placed in the curved groove (9) of the base (2), has a curved part (20) as shown in FIG. 9. The curved part (20) and the connection face (8A) are approximately in the state of a plane as the reed (19) is placed in the curved groove (9) of the base (2). Press the suitable position at two ends of the reed (19) to form a positioning part (21). Two ends of the positioning part (21) have the first, second coupling holes (22A)(22B). The first coupling hole (22A) extends at the suitable distance to form a one-piece shaft sleeve (23) which is with irregular burr for coupling one end of the shaft lever (15).

A shaft lever (15) is to penetrate through the guide tube (12) of the base (2), the first, second coupling holes (22A)(22B) of the reed (19) and eventually one end is inserted into the connection hole (14) of the driven lever (17); for this reason, the first, second coupling holes (22A)(22B) are able to move along the shaft lever (15). One end of the shaft lever (15) is inserted into the connection hole (14) of the driven lever (17) and the other end of the shaft lever (15) is bulging out of the guide tube (12) as shown in FIG. 3. Owing to the irregular burr on the shaft sleeve (23) of the reed (19), the shaft lever (15) can be fixed without dropping.

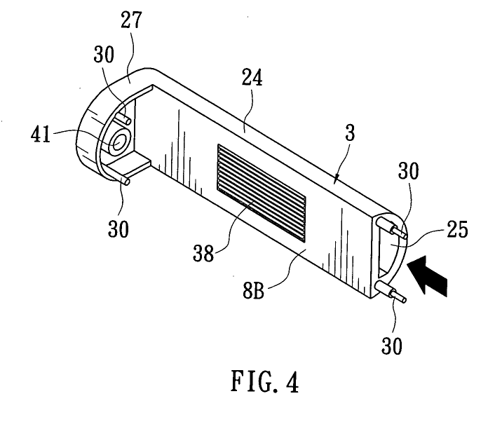

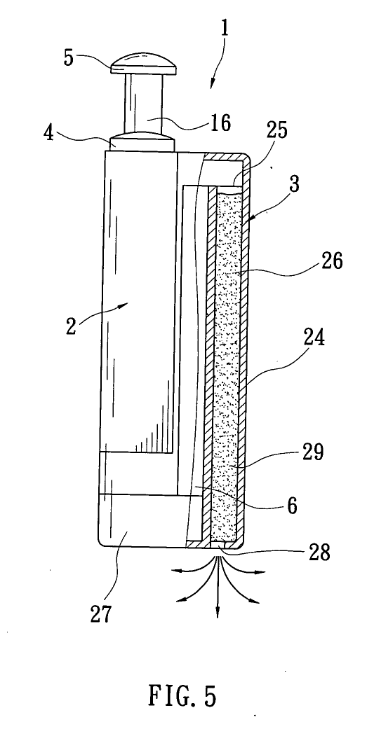

As FIG. 4 shows, a cover (3) approximately L-shaped has a containing fragrant-material part (24) and a bracket (27). The plural connection stub (30), in accordance with the sleeve hole (11) of the base (2), and a filler opening (25) are at the top end of the containing fragrant-material part (24). The extension of the filler opening (25) is a containing tank (26). The containing tank (26) is a hollow column extending to connect with the air vent (28) of the bracket (27). Because the aperture of the air vent (28) is smaller than that of the containing tank (26), fragrant materials will not fall down as being refilled via the filler opening (25) in the containing tank (26); furthermore, fragrance can be spread out via air vent (28) as shown in FIG. 5. One end of the bracket (27) also has the plural connection stub (30). The connection stub (30) described above are to be inserted into the sleeve holes (11) of the base (2). A coupling tube (41) is in the bracket (27) opposite to the guide tube (12) of the base (2). Consequently, the end of the shaft lever (15), bulging out of the guide tube (12), can be placed into the coupling tube (41). In this way, the cover (3) is able to combine with the base (2) together and then the inner of the cover (3) is formed into another connection face (8B). An antislip strip (38) is attached to the connection face (8B) opposite to the curved groove (9).

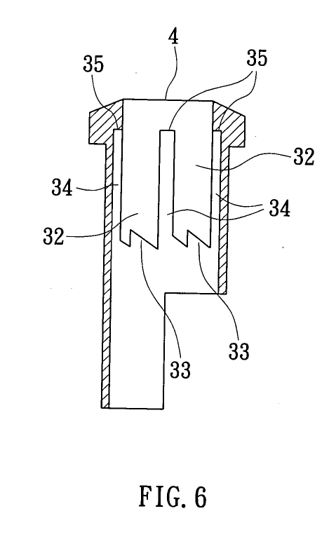

Referring to FIG. 6, the pressing structure of the present invention is to couple the sleeve tube (4) and the shaft hole (10) of the base (2) together. The plural convex positioning block (32) is arranged annularly in the sleeve tube (4) and the bottom of the positioning block (32) has a springing-away groove (33). The guide track (34) is formed between two positioning blocks (32) and the top of the guide track (34) has a springing-return groove (35).

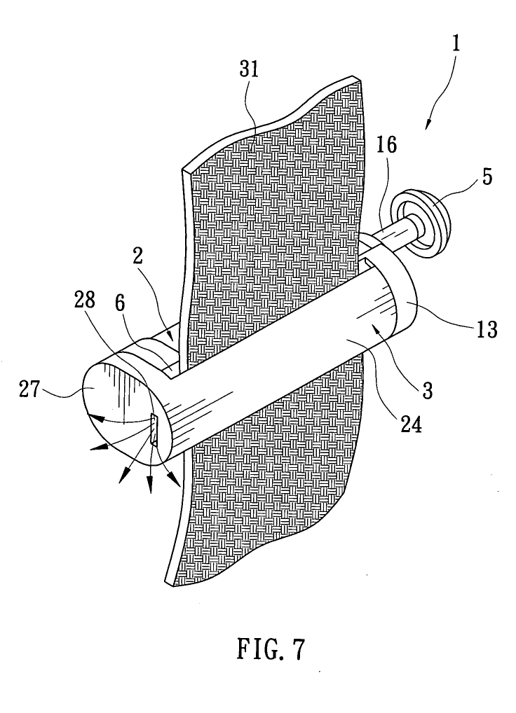

According to the above description, the way of combing the base (2) with the cover (3) is to insert the connection stub (30) of the cover (3) into the sleeve hole (11) of the base (2). Then, a containing space (6) is formed between the base (2) and the cover (3) for containing the safety belt (31) as shown in FIG. 7.

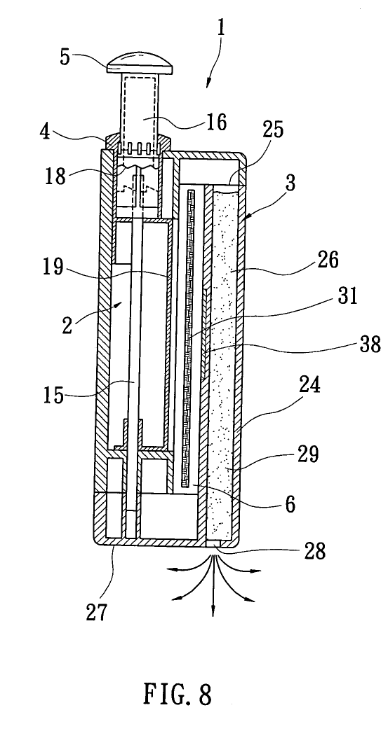

Referring to FIG. 7, FIG. 8 and FIG. 9, the installation of the present invention is to press the press-button (5), which drives the motive lever (16) having a downward movement so that the serrated end (18) of the motive lever (16) presses the side face of V-shaped groove (36) of the driven lever (17) to drive the driven lever (17) also having a downward movement. As the convex block (37) of the driven lever (17) moves downwardly along the inner of the sleeve tube (4) to the bottom of the positioning block (32), the convex block (37) revolves to slip into the springing-away groove (33) and the downward movement will stop; at the same time, the curved part (20) of the reed (19) bends toward the containing space (6) to fasten the safety belt (31) tightly with the antislip strip (38) in the containing space (6).

Moreover, the step of moving the present invention is to press the press-button (5) to drive the motive lever (16) and driven lever (17) having a downward movement again. After the convex block (37) of the driven lever (17) leaves the springing-away groove (33), the curved part (20) of the reed (19) goes back to a plane condition and loosens the safety belt (31) in the containing space (6) so that the safety belt adjuster (1) is able to move on the safety belt (31) for adjusting the length of the safety belt (31).

Referring to FIG. 3, fill fragrant materials (24) in the safety belt adjuster (1) is to remove the cover (3) from the base (2) in the direction of the arrow (39). Take the cover (3) and fill fragrant materials (29) via the filler opening (25) in the containing tank (26). Finally, place the safety belt (31) in the containing space (6), and combine the base (2) with the cover (3) together in the backward direction of the arrow (39).

1. An improved structure of safety belt adjuster comprising:
a base;
a sleeve tube coupling the shaft hole and placed in the base;
a motive lever placed in the sleeve tube;
a driven lever;
a reed placed in the curved groove of the base having a curved part;
a shaft lever penetrating through the guide tube, the first, second coupling holes of the reed and eventually one end is inserted into the connection hole of the driven lever;
a cover;
wherein the base is approximately L-shaped, whose one side is a circular face and the other side is a connection face; the connection face has a curved groove in accordance with the circular face, and one end of the curved groove extends to have a shaft hole; the plural sleeve hole and guide tube are at one end of the base and the sleeve cover, also with the plural sleeve hole, is at the other end of the base;
wherein the inner of the sleeve tube has the plural positioning block arranged annularly and the bottom of the positioning block has a springing-away groove; the guide track is formed between two positioning blocks and on top of said guide track has a springing-return groove;
wherein the front end of the motive lever is to combine with a press-button; the back end of the motive lever has an opening and has the plural convex guide block arranged annularly in the suitable position of the outer side for wedging into the guide track of the sleeve tube;
wherein the front end of the driven lever is inserted into the motive lever; a connection hole and convex blocks, arranged annularly on the outer edge, are at the back end of the driven lever;
wherein the positioning part formed by pressing the suitable position at two ends of the reed; the first, second coupling holes are at two ends of the positioning part and the first coupling hole extends at the suitable distance to form a one-piece shaft sleeve with irregular burr; and
wherein the cover is approximately L-shaped having a containing fragrant-material part and a bracket; the top end of the containing fragrant-material part has a filler opening and the filler opening extends to have a containing tank; the containing tank is a hollow column extending to connect with the air vent of the bracket and the air vent is to spread out fragrance; the plural connection stub is arranged at the top end of the containing tank and also arranged on one end of the bracket to be inserted into the sleeve hole of the base.

2. An improved structure of safety belt adjuster of claim 1, the back end of the motive lever is formed into the serrated end, which wedges into the V-shaped groove of the driven lever in the state of an eccentric.

3. An improved structure of safety belt adjuster of claim 1, wherein the inner of the cover is formed into another connection face as the base combines with the cover and an antislip strip is attached to the connection face opposite to the curved groove.
